(19) United States
(12) Patent Application Publication
(10) Pub. No.: US 2006/0112567 A1
(43) Pub. Date: Jun. 1, 2006

(54) Effort-saving cable shears

(76) Inventor: Ming-Chieh Tsai, Hsin Chu City (TW)

Correspondence Address: LEONG C LEI, PMB # 1008, 1867 YGNACIO VALLEY ROAD, WALNUT CREEK, CA, 94598, US

(21) Appl. No.: 10/996,428

(22) Filed: Nov. 26, 2004

(51) Int. Cl. B26B 13/00

(52) U.S. Cl. 30/252

(57) ABSTRACT

A pair of effort-saving cable shears having both blades respectively adapted with an arm including an inner and an outer axle holes with inner axle hole pivoted to a central axle hole at mid of the handlebar and outer axle to tail axle hole in the blade to provide biased leverage connection; and a bolt at tail axis as the support while operating both handlebars to swing and further to open and close for cutting by having both arms to draw both blades with a threaded sheath as support.

### BACKGROUND OF THE INVENTION

1. Technical Field of the Invention

The present invention is related to a pair of effort-saving cable shears, and more particularly, to one that has both blades respectively pivoted to an arm offering labor-saving by run-out leverage for easier cutting.

2. Description of the Prior Art

As illustrated in FIGS. 1 and 2 of the accompanying drawings, the prior art of a pair of cable shears is essentially comprised of a left handlebar (11), a left blade (12), a right handlebar (13), a right blade (14) alternatively combined by axis. Wherein, both handlebars (11) (13) are pivoted to each other at their centers by an axle bolt (15) before being separately and alternatively pivoted to both blades (12) (14) by means of both externally provided bolts (16) (17); and both blades (12) (14) are further alternatively pivoted in position by another bolt (18) at where approximately at their mid portions. However, for so many years after its introduction into the market, the prior art is found nothing innovative and lacking in changeability to meet the needs of the users today.

### SUMMARY OF THE INVENTION

The primary purpose of the present invention is to provide an effort-saving pair of cable shears to apply greater shear on both blades at economized effort. To achieve the purpose, both arms are respectively pivoted to where between both handlebars and blades. In use, both handlebars are pulled with their respective tail bolts as the support to swing to make the shear and cut through both blades drawn by both arms with a threaded sheath as the support in a fashion of biased leverage connection provided by both arms.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a prior art as assembled.

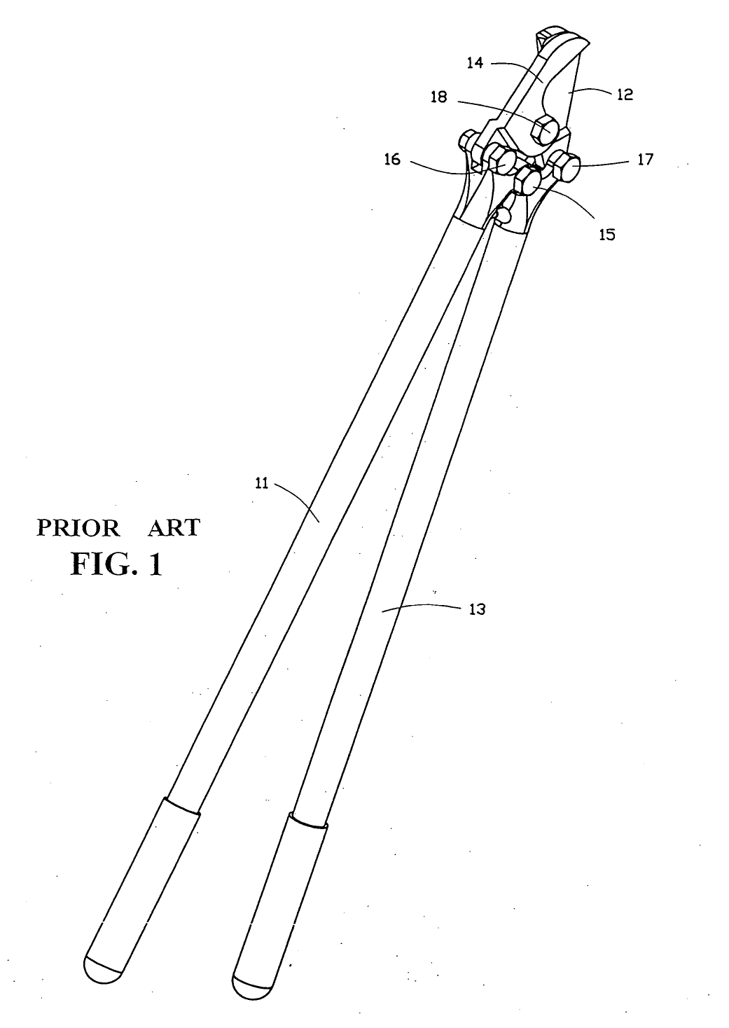

FIG. 2 is a schematic view showing the opening and closing status of the prior art.

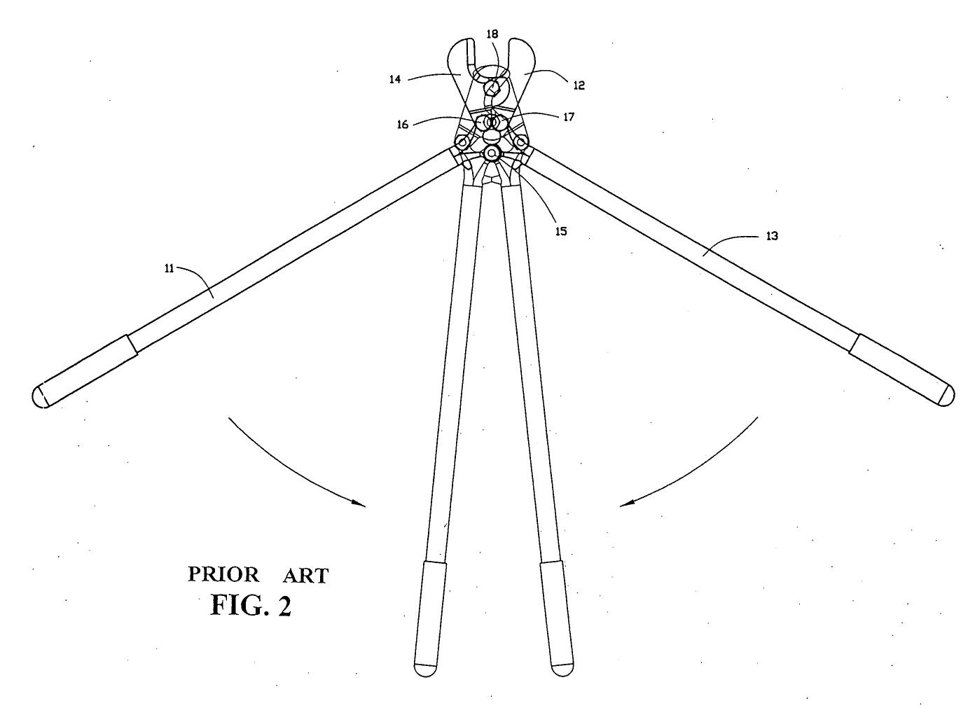

FIG. 3 is an exploded view of the present invention.

FIG. 4 is a perspective view of the present invention as assembled.

FIG. 5 is a layout view of the assembly of the present invention.

FIG. 6 is schematic view showing that the present invention is in its opening status.

FIG. 7 is schematic view showing that the present invention is in its closed status.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

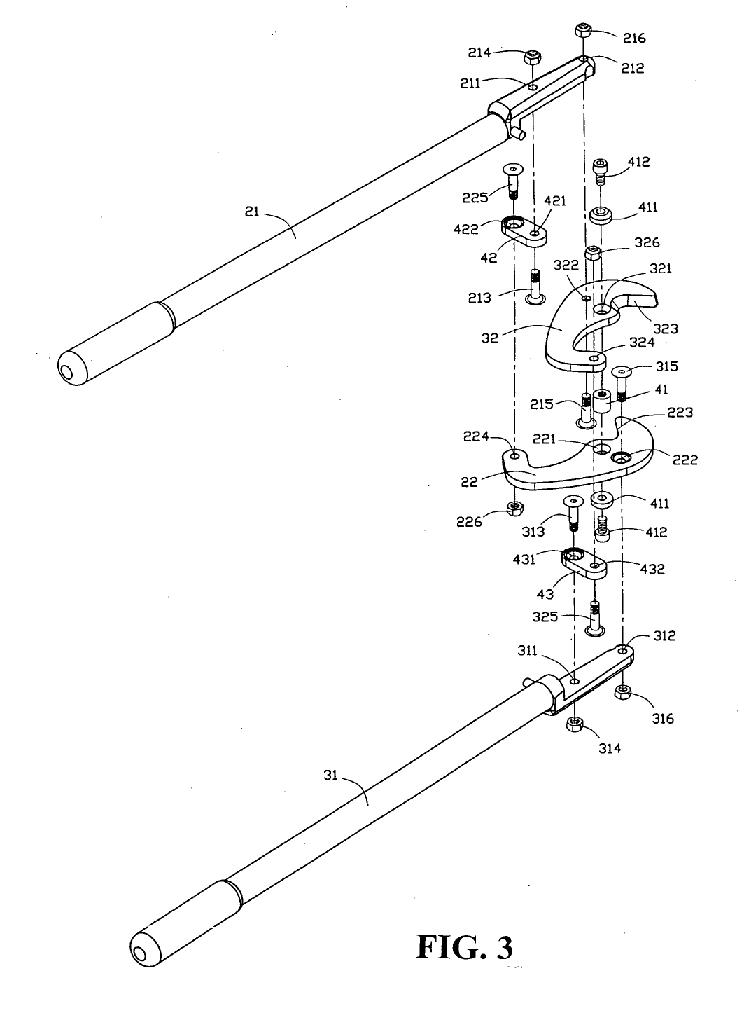

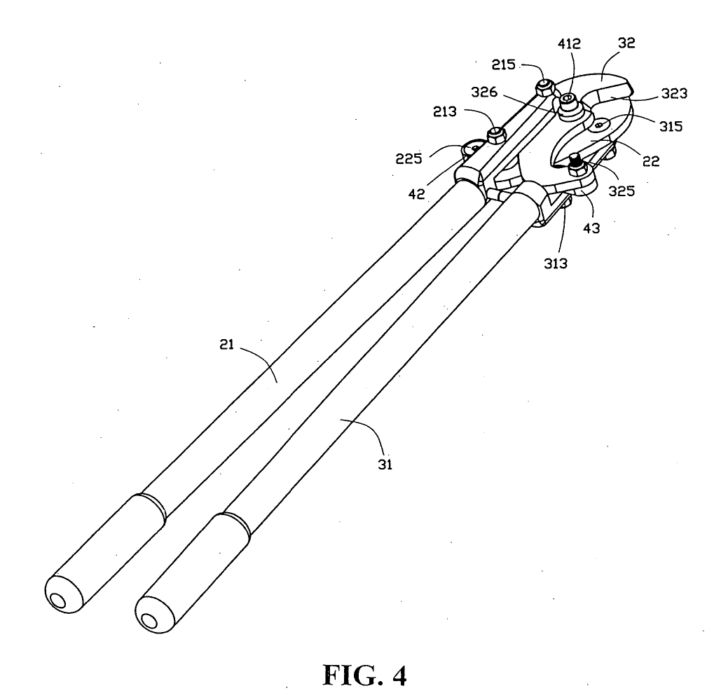

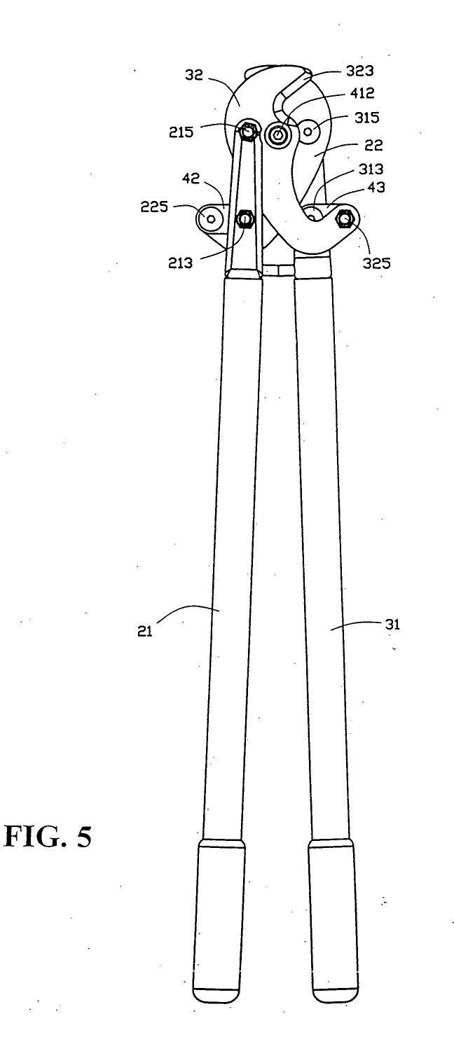

Referring to FIGS. 3, 4, and 5, a pair of cable shears of the present invention is comprised of a left handlebar (21), a left blade (22), a right handlebar (31) and a right blade (32). A threaded sheath (41) is provided in a primary axle hole (221) of the left blade (22) and a primary axle hole (231) of the right blade (32); and both ends of the sheath (41) are respectively retained with a washer (411) and a bolt (412) to permit that both of the left handlebar (21) and the left blade (22) are alternatively arranged with the right handlebar (31) and the right blade (32) to constitute a configuration of a pair of cable shears.

The end for connection of the left handlebar (21) is provided with a middle axle hole (211) and a tail axle hole (212). The middle axle hole (211) is locked to an inner axle hole (421) of a left plate arm (42) by means of a bolt (213) and a nut (214) while the tail axle hole (211) is pivoted to a side axle hole (322) in the right blade (32) by means of an axle bolt (215) and a nut (216).

A side axle hole (222) is provided to the primary axle hole (221) and a tail axle hole (224) is provided at where in relation to the blade (223). The tail axle hole (224) is pivoted to an outer axle hole (422) of the left plate arm (42) by means of an axle bolt (225) and a nut (226). That is, the left blade (22) and the left handlebar (21) are connected to each other through the left plate arm (42).

Both of the inner axle hole (421) and the out axle hole (422) are provided on the surface of the left plate arm (42) with the inner axle hole (421) provided to the middle axle hole (211) of the left handlebar (21) and the outer axle hole (422) pivoted to the tail axle hole (224) of the left blade (22) for the left handlebar (21) and the left plate arm (42) to provide biased leverage labor-saving function.

A middle axle hole (311) and a tail end axle hole (312) are respectively provided to the connection end of the right handlebar (31). The middle axle hole (311) is locked to an inner axle hole (431) of a right plate arm (43) through an axle bolt (313) and a nut (314) while the tail axle hole (312) is pivoted to the side axle hole (222) of the left blade (22) with an axle bolt (315) and a nut (316).

A side axle hole (322) is provided to a primary axle (321) of the right blade (232), and a tail axle hole (324) is provided to the right blade (32) at where in relation to an edge (323) of the right blade (32). The tail axle hole (324) is pivoted to the outer axle hole (432) of the right plate arm (43) by means of an axle bolt (325) and a nut (326); that is, the right blade (32) and the right handlebar (31) are connected to each other through the right plate arm (43).

Both of the inner axle hole (431) and the outer axle hole (432) are provided on the surface of the right plate arm (43). The inner axle hole (431) is pivoted to where the middle axle hole (311) of the right handlebar (31) is located, and the outer axle hole (432) is pivoted to the tail axle (324) and the right blade (32) for the right plate arm (43) to provide biased leverage laborsaving function.

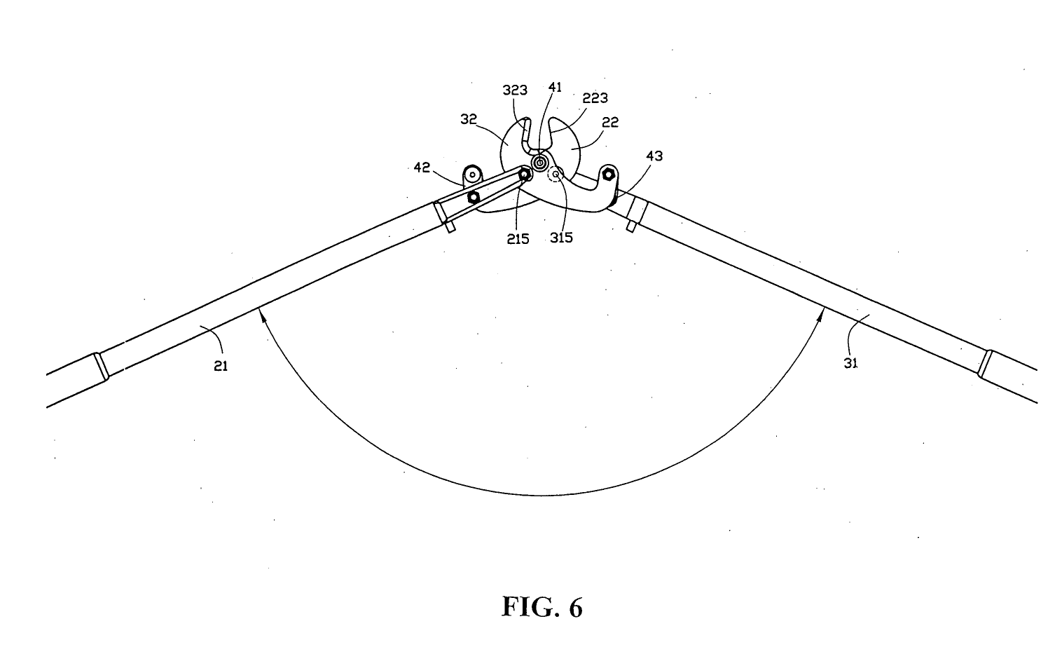

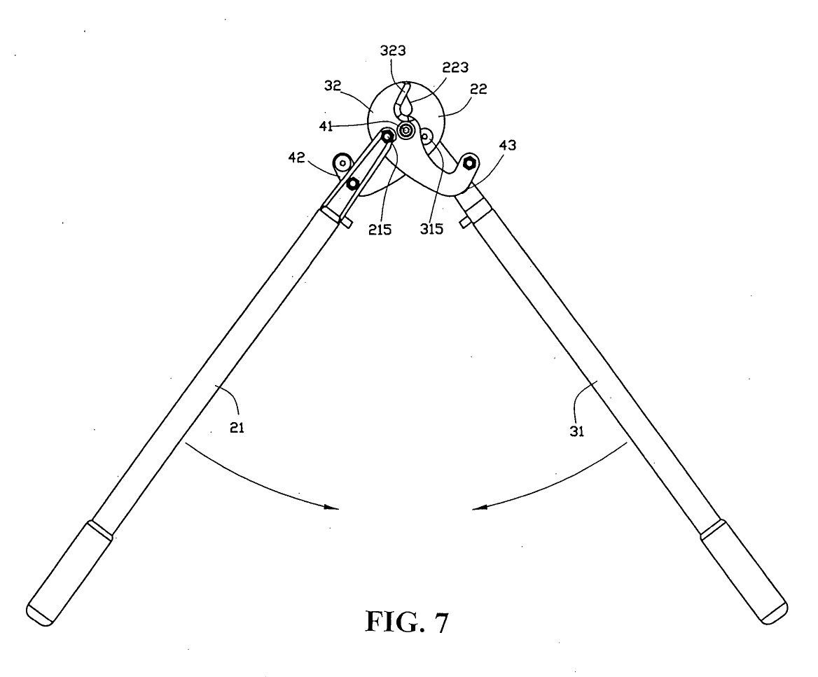

Furthermore, as illustrated in FIGS. 6 and 7, both of the left and the right handlebars (21) (31) are pulled to swing by having both tail axle bolts (215, 315) respectively of the left and the right handlebars (21, 31) as the support; and both of the left and the right blades (22, 32) as drawn by the left and the right plate arms (42, 43) disposed at the middle sections of the left and the right handlebars (21, 31) to cross to shear and cut with the threaded sheath as the support. The cut is exercised by taking advantage of biased leverage connection provided by both of the left and the right plate arms (42, 43) to apply greater shear on both edges (223, 323) respectively of the left and the right blades (22, 32) for providing greater economized shear to cut the cable.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pair of cable shears providing effort-saving cutting function is essentially comprised of a left handlebar adapted with a left blade and a right handlebar adapted with a right blade alternatively pivoted to each other by means of a threaded sheath being provided in a primary axle hole in the left blade and another primary axle hole in the right blade with both ends of the threaded sheath being respectively secured with a washer and a bolt;
a connection end of the left handlebar being respectively provided with a middle axle hole and a tail axle hole; the middle axle hole being fastened to an inner axle of a left plate arm by means of an axle bolt and a nut, and the tail axle hole being pivoted to a side axle hole in the right blade also by means of an axle bolt and a nut;
a side axle hole being provided to the primary axle hole in the left blade; a tail axle hole being provided at the relative end of the edge of the left blade and pivoted to an external axle hole disposed in the left plate arm with an axle bolt and a nut; and the left blade being connected to the left handlebar through the left plate arm;
an inner axle hole and the outer axle hole being provided on the surface of the left plate arm; the inner axle hole being provided to where the middle axle hole in the left handlebar axle being located, and the outer axle hole being pivoted to the tail axle hole in the left blade;
a connection end of the right handlebar being respectively provided with a middle axle hole and a tail axle hole; the middle axle hole being fastened to an inner axle of a right plate arm by means of an axle bolt and a nut, and the tail axle hole being pivoted to a side axle hole in the left blade also by means of an axle bolt and a nut;
a side axle hole being provided to the primary axle hole in the right blade; a tail axle hole being provided at the relative end of the edge of the right blade and pivoted to an external axle hole disposed in the right plate arm with an axle bolt and a nut; and the right blade being connected to the right handlebar through the right plate arm;
an inner axle hole and an outer axle hole being provided on the surface of the right plate arm; the inner axle hole being provided to where the middle axle hole in the right handlebar axle being located, and the outer axle hole being pivoted to the tail axle hole in the right blade; and
both handlebars being pulled to execute swing motion with both tail axle bolts as a support; both blades drawn by both plate arms providing biased leverage connection to exercise the cutting by both blades operating alternatively with the threaded sheath as a support to provide greater shear at economized efforts.

2. The pair of cable shears of claim 1; wherein, all axle bolts and the nuts used for connection is replaced with rivets for achieving the same connection purpose.
